(19) United States
(12) Patent Application Publication
(10) Pub. No.: US 2014/0082439 A1
(43) Pub. Date: Mar. 20, 2014

(54) TEST DEVICE FOR MOBILE COMMUNICATION TERMINAL AND TEST METHOD FOR MOBILE COMMUNICATION TERMINAL

(71) Applicant: ANRITSU CORPORATION, Kanagawa (JP)

(72) Inventor: Kazunori Kitagawa, Kanagawa (JP)

(73) Assignee: ANRITSU CORPORATION, Kanagawa (JP)

(21) Appl. No.: 13/949,752

(22) Filed: Jul. 24, 2013

(30) Foreign Application Priority Data
Sep. 20, 2012 (JP) 2012-207622

(51) Int. Cl. H04W 24/00

(52) U.S. Cl. CPC H04W 24/00
USPC 714/712

(57) ABSTRACT

A test device 50 includes a message processing unit 53 capable of generating a message to be transmitted to a mobile communication terminal 10 that is a test subject, according to a test scenario, a layer processing unit 54 that processes data of the generated message for each layer, a communication unit 55 capable of transmitting data of the message processed by the layer processing unit to the mobile communication terminal, a log data generation unit 56 that generates as log data, and a specific message processing unit 51 that specifies log data in downlink related to a designated log and outputs communication data included in the specified log data as specific communication data to the layer processing unit, in which the test device 50 outputs the specific communication data from the communication unit to the mobile communication terminal through the layer processing unit.

### TECHNICAL FIELD

The present invention relates to a test device for a mobile communication terminal and a test method for a mobile communication terminal (hereinafter, simply referred to as a test device or a test method) which test mobile communication terminals such as mobile phones.

### BACKGROUND ART

When new communication terminal devices such as mobile phones and mobile devices are developed, it is necessary to test whether the communication terminal devices properly operate in an environment where the communication terminal devices are actually used. Then, in a case of testing whether communication terminal devices under development function as designed, the communication terminal devices are tested using a test device.

The test device functions as a pseudo base station and performs a communication with a communication terminal device based on a communication protocol of a predetermined communication standard. In this case, the test device stores log information of the communication for each layer based on the communication protocol (for example, see Patent Document 1).

The test device operates according to a test scenario (data in which communication sequence and operation sequence for performing a test are described). A tester creates in advance its own test scenario, or creates the test scenario based on log information by acquiring the log information of an actual communication (log to scenario conversion). When the test scenario is created, a scenario conversion device which creates and edits a test scenario may be used (for example, see Patent Document 2).

For example, the tester can confirm log information of a communication displayed on a display unit by executing the created test scenario in a test device. Then, for example, in a case where an abnormality has occurred in the log information or in a case where a place to be re-confirmed has been present in the test scenario, the tester re-executes the test scenario in the test device so as to determine the cause of the abnormality.

### RELATED ART DOCUMENT

### Patent Document

[Patent Document 1] Japanese Unexamined Patent Application Publication No. 2009-147640

[Patent Document 2] Japanese Unexamined Patent Application Publication No. 2008-124993

### DISCLOSURE OF THE INVENTION

### Problem That the Invention Is To Solve

However, it may require a long time to complete a test using a test scenario. For example, when an abnormal place is in the second half of the test scenario, it may take many hours up to reach the abnormal place from when the test scenario is re-executed. Even if a tester reduces a data amount by modifying a test scenario and re-executes the test scenario after being modified in a test device, the modification requires effort and time.

In view of the circumstances described above, an object of the present invention is to provide a test device and a test method which can shorten the time of a reproduction test and reduce effort required for the reproduction test.

### Means For Solving the Problem

In order to achieve the above object, a test device (50) for a mobile communication terminal according to claim 1 of the present invention includes a message processing unit (53) capable of generating a message to be transmitted to the mobile communication terminal (10) that is a test subject, according to a test scenario describing content and sequence of transmitting and receiving the message based on a predetermined communication protocol, a layer processing unit (54) that is configured of a plurality of layers based on the communication protocol and processes data of the generated message for each layer, a communication unit (55) capable of transmitting data of the message processed by the layer processing unit to the mobile communication terminal, a log data generation unit (56) that generates as log data, logs of communication data between layers in the layer processing unit, a display unit (41) that displays the logs based on the log data, an operation unit (43) that designates any log from the logs displayed on the display unit, and a specific message processing unit (51) that specifies log data in downlink related to the designated log and outputs communication data included in the specified log data as specific communication data to the layer processing unit, in which the test device outputs the specific communication data from the communication unit to the mobile communication terminal through the layer processing unit.

The specific message processing unit retransmits specific communication data related to any designated log data, among log data for each layer that is processed by the layer processing unit. In other words, the test device for a mobile communication terminal can reproduce an operation of a scenario (message) of a designated location, among data of the test scenario. Thus, it is possible to shorten the time of the reproduction test, and to reduce effort required for a tester to test because there is no need to modify the test scenario.

In the test device for a mobile communication terminal related to claim 2 of the present invention, according to claim 1, the specific message processing unit specifies a layer of a destination of the specific communication data based on log header information included in the designated log data, and outputs the specific communication data to the specified layer.

Since the specific message processing unit outputs specific communication data to the layer of the specified destination, the layer processing unit can perform layer processing in the specified layer and transmit data.

In the test device for a mobile communication terminal related to claim 3 of the present invention, according to claim 1, the specific message processing unit includes a communication data editing unit (511) that edits the specific communication data related to the designated log data, and when the specific communication data is edited, outputs the edited specific communication data.

Accordingly, it is possible for a tester to confirm a response of a mobile communication terminal in communication data after being edited.

In the test device for a mobile communication terminal related to claim 4 of the present invention, according to claim 1, the communication unit includes a digital interface that transmits a baseband signal of data of the message processed by the layer processing unit.

Accordingly, the test device for a mobile communication terminal can perform a communication test without passing through a RF signal processing unit of the mobile communication terminal.

In the test device for a mobile communication terminal related to claim 5 of the present invention, according to claim 1, the specific message processing unit selects and outputs as the specific communication data, any one piece of communication data among communication data between layers including information related to a message included in the designated log data.

Accordingly, the operation of the specific message processing unit is not limited to outputting communication data between layers that directly correspond to the designated log data. In other words, the specific message processing unit may select any one among the communication data including a message included in the designated log data.

In the test device for a mobile communication terminal related to claim 6 of the present invention, according to claim 5, the specific message processing unit selects as the specific communication data, communication data to be output to a bottom layer among communication data between layers.

Accordingly, the layer processing unit may perform layer processing in the bottom layer on specific communication data including the message.

In order to achieve the above object, a test method for a mobile communication terminal according to claim 7 of the present invention includes a message generation step that generates a message to be transmitted to a mobile communication terminal (10) that is a test subject, according to a test scenario describing content and sequence of transmitting and receiving a message based on a predetermined communication protocol, a layer processing step that processes data of the generated message for each layer, in a plurality of layers based on the communication protocol, a communication step that transmits data of the message that is processed in the layer processing step to the mobile communication terminal, a log data generation step (ST103) that generates as log data, a log of communication data between layers in the layer processing step, a log display step (ST104) that displays the log based on the log data, a log designation step (ST105) that designates any log from the displayed logs, a specific communication data output step (ST107) that specifies log data in downlink related to the designated log and outputs communication data included in the specified log data as specific communication data, a second layer processing step (ST108) that processes the specific communication data in the layer, and a second communication step (ST109) that transmits the specific communication data processed in the second layer processing step to the mobile communication terminal.

In the test method for a mobile communication terminal related to claim 8 of the present invention, according to claim 7, the specific message processing step specifies a layer of a destination of the specific communication data based on log header information included in the designated log data, and outputs the specific communication data to the specified layer.

The test method for a mobile communication terminal related to claim 9 of the present invention, according to claim 7 further includes a communication data editing step that edits the specific communication data related to the designated log data, in which when the specific communication data is edited, the specific message processing step outputs the edited specific communication data.

In the test method for a mobile communication terminal related to claim 10 of the present invention, according to claim 7, the communication step and the second communication step transmit as a digital base band signal, data of the message processed by the layer processing step or the specific communication data processed by the second layer processing step to the mobile communication terminal.

In the test method for a mobile communication terminal related to claim 11 of the present invention, according to claim 7, the specific message processing step selects and outputs as the specific communication data, any one piece of communication data among communication data between layers including information related to a message included in the designated log data.

In the test method for a mobile communication terminal related to claim 12 of the present invention, according to claim 11, the specific message processing step selects as the specific communication data, communication data to be output to a bottom layer among communication data between layers.

### Advantage of the Invention

According to the present invention, it is possible to shorten the time of a reproduction test and to reduce effort required for a test.

### BRIEF DESCRIPTION OF THE DRAWINGS

FIG. 1 is a block diagram illustrating a configuration of a system including a test device according to an embodiment of the present invention.

FIG. 2 illustrates a configuration of log data.

FIG. 3 is a flowchart mainly illustrating an operation of the test device.

FIG. 4 illustrates an example of a first display screen.

FIG. 5 illustrates an example of a second display screen.

FIG. 6 illustrates a display screen (second display screen) of log data of a reproduction test result by the operation of a test device according to a second embodiment.

### BEST MODE FOR CARRYING OUT THE INVENTION

Hereinafter, embodiments of the present invention will be described referring to the drawings.

### First Embodiment

### Configuration of Test Device

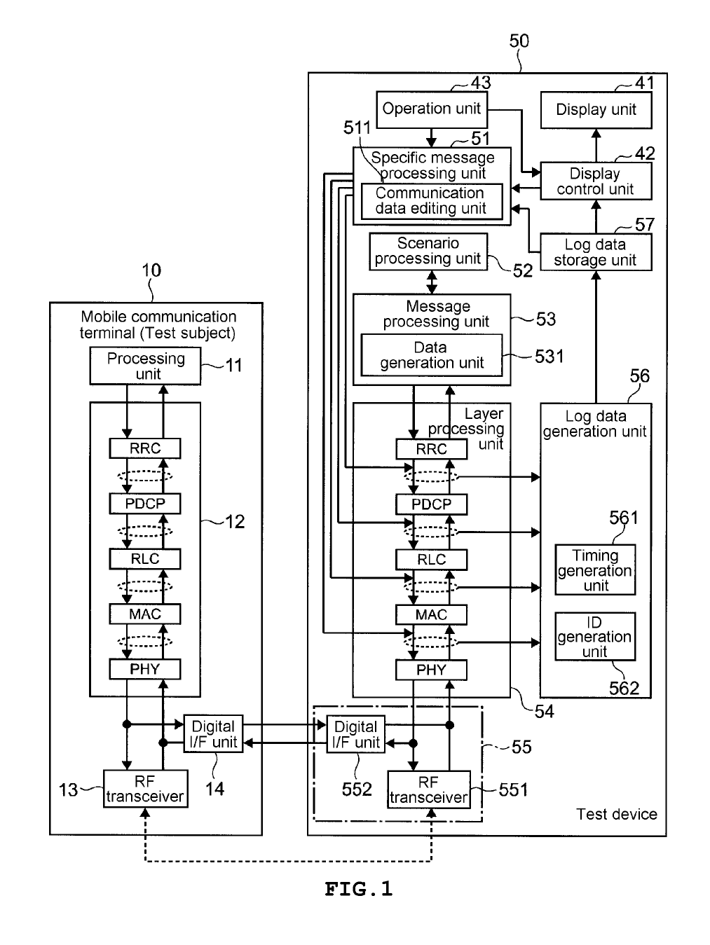

FIG. 1 is a block diagram illustrating a configuration of a system including a test device 50 according to an embodiment of the present invention. The system includes a mobile communication terminal device 10 (hereinafter, simply referred to as a communication terminal) and a test device 50.

The communication terminal 10 is a mobile phone, a data communication terminal device, a semiconductor device for mobile communication used therein or the like, and is a target device of a communication test by the test device 50. The test device 50 functions as a pseudo base station and tests the communication terminal 10.

The test device 50 includes an operation unit 43, a display unit 41 and a display control unit 42.

The operation unit 43 is a device that receives an operation by an operator including a tester. The operation unit 43 is a device such as, for example, a keyboard, a mouse, and a touch panel.

The display unit 41 displays a display screen generated by the display control unit 42. The display unit 41 is a device such as, for example, a liquid crystal.

The display control unit 42 generates a screen to be displayed on the display unit 41, and particularly generates a screen for displaying a log. Further, the display control unit 42 receives operation information that the operator inputs using the operation unit 43, and performs a processing based on the operation information.

The operation unit 43, the display unit 41 and the display control unit 42 are provided, for example, as a separate device from the test device 50, and the separate device may be connected to the test device 50. As the separate device, a Personal Computer (PC) and the like are typically used.

The test device 50 includes a scenario processing unit 52, a message processing unit 53, a layer processing unit 54, a log data generation unit 56, a log data storage unit 57, a specific message processing unit 51 and a communication unit 55.

The scenario processing unit 52 can acquire a scenario file that is data of a test scenario for performing a communication test with the communication terminal 10 from an external device which is not shown and stores the acquired scenario file, or can output the scenario file to the message processing unit 53. The external device is, for example, a storage device which is not shown, the aforementioned PC, or the like, and stores the scenario file.

The message processing unit 53 generates a message to be transmitted to the communication terminal 10, according to the test scenario acquired from the scenario processing unit 52. Further, the message processing unit 53 processes data of a message received from the communication terminal 10 through the layer processing unit 54.

The data generation unit 531 of the message processing unit 53 generates user data when it is necessary to transmit a message including the user data. The test device 50 may store in advance the user data, may acquire the user data from the external device, or may cause a random data generator to generate the user data. When the user data is generated by the data generation unit 531, the message processing unit 53 generates a message related to the user data.

The layer processing unit 54 performs a communication protocol processing (a processing for each layer based on a communication protocol) corresponding to a predetermined communication standard on the data of a message generated by the message processing unit 53. The layer processing unit 54 outputs the communication content to the log data generation unit 56 whenever each layer performs a processing. The layer processing unit 54 sends the data of the message acquired by the communication protocol processing to the communication unit 55, and processes the data received from the communication terminal 10 through the communication unit 55 and sends the processed data to the message processing unit 53.

For example, the layer processing unit 54 performs a communication protocol processing of Long Term Evolution (LTE) scheme. In this case, there are layers of a Radio Resource Control (RRC), a Packet Data Control Protocol (PDCP), a Radio Link Control (RLC), a Media Access Control (MAC), and a PHYsical (PHY) from the top.

In downlink, each layer performs its own processing on communication data 36 received from an upper layer and sends the processed data to a lower layer. In uplink, each layer performs its own processing on communication data received from a lower layer and sends the processed data to an upper layer.

Incidentally, although not shown, the test device 50 may have a configuration including a plurality of sets of the communication unit 55, the layer processing unit 54, and the message processing unit 53. A set of the communication unit 55, the layer processing unit 54, and the message processing unit 53 simulates an operation of a base station. Therefore, since the test device 50 includes the plurality of sets, for example, one test device 50 can perform, for example, a test of a hand-over operation by which a mobile communication terminal switches a base station of a communication destination. Furthermore, in this case, the test device 50 includes a coupler (not shown) that combines signals transmitted from respective sets and outputs the combined signals to the communication terminal 10, and distributes signals received from the communication terminal 10 to each set.

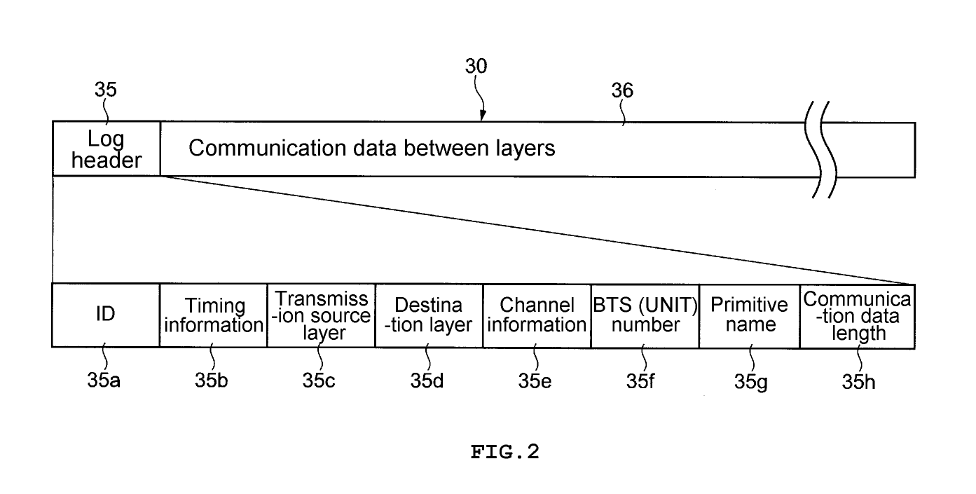

The log data generation unit 56 generates log data from communication data that is communication content to be output from each layer of the layer processing unit 54. FIG. 2 illustrates a configuration of log data. The log data 30 includes a log header (log header information) 35 and communication data 36 between layers. The log header 35 includes ID 35a that will be described later, timing information 35b that will be described later, a transmission source layer 35c and a destination layer 35d respectively indicating a transmission source and a destination of communication data between layers, channel information 35e indicating a type of a channel of communication data, Base Transceiver Station (BTS) number 35f for identifying a plurality of base stations when the test device 50 simulates the plurality of base stations, a primitive name 35g indicating a primitive that is a setting instruction of communication data, and a communication data length 35h indicating a data length of communication data having a variable length.

As illustrated in FIG. 1, the log data generation unit 56 includes a timing generation unit 561 and an ID generation unit 562. The timing generation unit 561 generates timing information. The ID generation unit 562 generates an identifier (ID 35a) for identifying a log (log data 30). ID 35a is a sequence number from a start of a test.

The log data generation unit 56 acquires information of the transmission source layer 35c, the destination layer 35d, the channel information 35e, the BTS number 35f, the primitive name 35g and the communication data length 35h in the log header 35, using any one of or a combination of a scheme in which the log data generation unit 56 identifies a transmission source of communication data, a scheme in which the log data generation unit 56 analyzes the received communication data, and a scheme in which the log data generation unit 56 receives the communication data along with the above information transmitted from the layer processing unit 54. The log data generation unit 56 further adds the ID 35a and the timing information 35b to the acquired information to generate the log header.

The log data storage unit 57 stores log data 30 generated in the log data generation unit 56. The log data storage unit 57 is a mass storage medium such as a Hard Disk Drive (HDD) and a flash memory. The log data storage unit 57 may be an external storage device separate from the test device 50.

The specific message processing unit 51 functioning as a processing unit acquires log data 30 from the display control unit 42 and outputs communication data 36 related to the log data 30 to the layer processing unit 54. Alternatively, instead of the display control unit 42, the specific message processing unit 51 may acquire the log data 30 from the log data storage unit 57. Further, instead of the display control unit 42, the specific message processing unit 51 may receive operation information of an operator that is input through the operation unit 43 and performs a processing based on the operation information. The processing unit may function by cooperation of the display control unit 42 and the specific message processing unit 51.

The communication data editing unit 511 edits the communication data 36 based on the operation information generated through the operation unit 43 of the operator. When the communication data is edited by the operator, the specific message processing unit 51 outputs the edited communication data 36 to the layer processing unit 54.

The communication unit 55 includes a RF transceiver 551 and a digital I/F (digital interface) unit 552.

The RF transceiver 551 generates a RF signal by coding, modulating and frequency-converting the data subjected to the communication protocol processing in the layer processing unit 54 and transmits the RF signal to the communication terminal 10. In addition, the RF transceiver 551 receives the RF signal transmitted from the communication terminal 10, frequency-converts, demodulates and decodes the received RF signal, and transmits the RF signal to the layer processing unit 54. The RF transceiver 13 of the communication terminal 10 and the RF transceiver 551 of the test device 50 are connected by for example, a coaxial cable and transceive the RF signal.

The digital I/F unit 552 transmits the data subjected to the communication protocol processing in the layer processing unit 54 to the communication terminal 10. Further, the digital I/F unit 552 receives data transmitted from the communication terminal 10 and transmits the received data to the layer processing unit 54. The digital I/F unit 14 of the communication terminal 10 and the digital I/F unit 552 of the test device 50 are connected by for example, a digital cable, and thereby performing a high speed communication. The data to be communicated between the digital I/F units 552 and 14 is digital IQ data, that is, a baseband signal.

A final product of the communication terminal 10 generally does not have the digital I/F unit 14. However, the digital I/F unit 14 may be provided as a development debug.

The test device 50 mainly includes hardware such as a Central Processing Unit (CPU), a Random Access Memory (RAM), and a Read Only Memory (ROM) that are not shown. The test device 50, in addition to the CPU or instead of the CPU, may have a Programmable Logic Device (PLD) such as a Field Programmable Gate Array (FPGA), or a Digital Signal Processor (DSP), an Application Specific Integrated Circuit (ASIC) and the like.

The configuration of the test device 50 may be realized by only hardware, or may be realized by both hardware and software. In a latter case, the function of each functional block of the test device 50 shown in FIG. 1 is realized by a cooperation of hardware that is a processor such as the CPU and software stored in, for example, the ROM or other storage devices.

The communication terminal 10 includes the same layer processing unit 12 used in the communication scheme. Further, the communication terminal 10 includes a processing unit 11 that processes data obtained in the layer processing unit 12 and outputs the processed data to the layer processing unit 12, the RF transceiver 13 and the digital I/F unit 14.

### Operation of Test Device

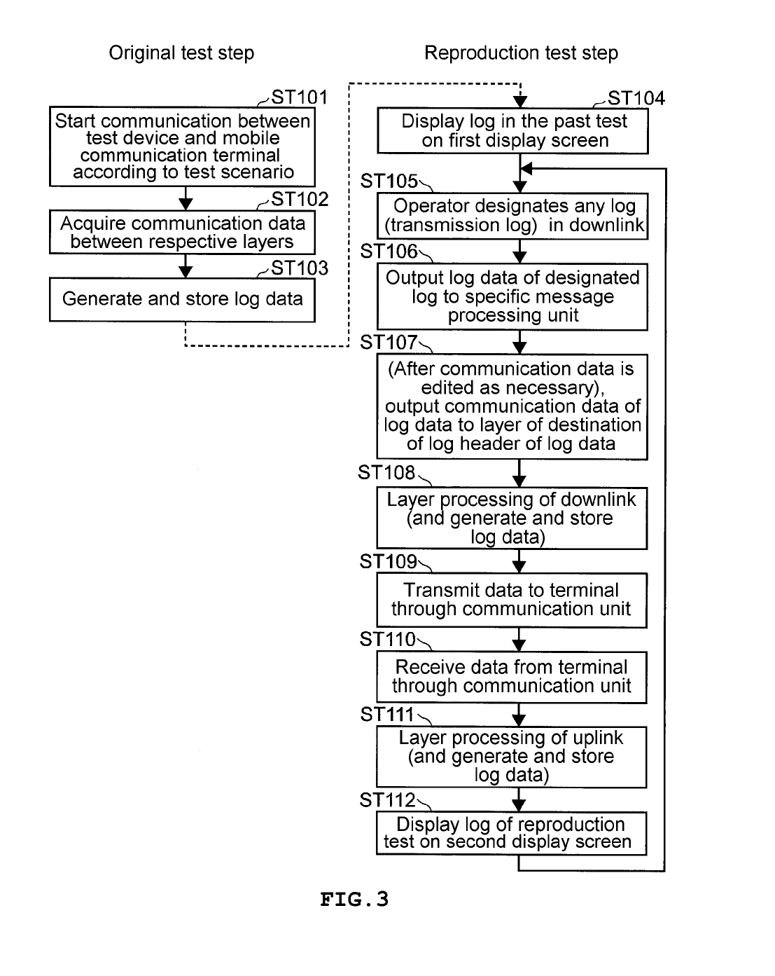

The operation of the test device 50 configured as described above will be described. FIG. 3 is a flowchart mainly illustrating an operation of the test device 50. The operation is roughly divided into two steps. One step is (1) an original test step, and another step is (2) a reproduction test step. The reproduction test is a test that reproduces a portion of the test by an original test scenario.

### (1) Original Test Step

The scenario processing unit 52 of the test device 50 starts a communication between the test device 50 and the communication terminal 10 according to the test scenario (step 101). The log data generation unit 56 acquires communication data 36 between respective layers (step 102). The log data storage unit 57 stores the log of the acquired communication data 36 as log data 30 (step 103).

### (2) Reproduction Test Step

If a portion of or an entirety of the test by the test scenario is terminated, the display control unit 42 displays a screen of the list of log data on the display unit 41. The display control unit 42 displays as the screen of log data, a first display screen that displays the log in the past test (the original test) (step 104).

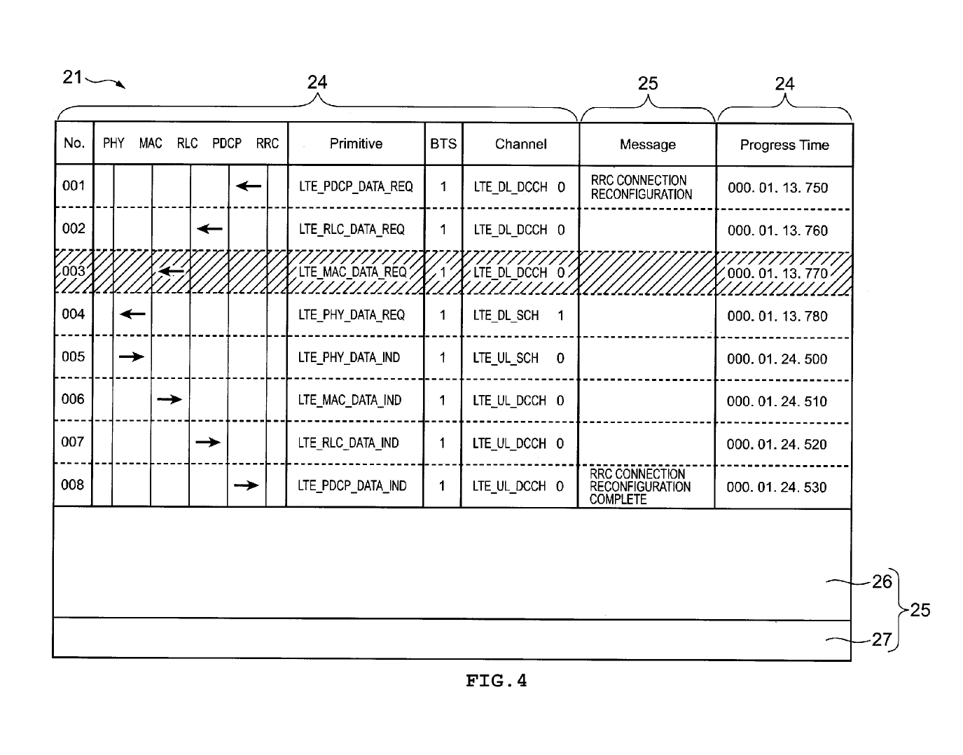

FIG. 4 illustrates an example of the first display screen. The first display screen 21 includes a log header information display area 24 in which information of the log header 35 is arranged and displayed in time sequence from top to bottom and a communication data information display area 25 in which content of communication data is displayed. FIG. 4 illustrates a small portion of log data that is generated in large amounts, specifically, log data of one response message from the communication terminal 10 side with respect to one transmission message from the test device 50 side.

The log header information display area 24 includes “No.”, “PHY” to “RRC”, “Primitive”, “Channel”, “BTS” and “Progress Time.” In other words, they are contents of information included in the log header 35 shown in FIG. 2.

“No.” is an identification number of each log data 30, and ID 35a is displayed as it is in the present embodiment.

“PHY” to “RRC” illustrate the layers and the direction in which data flows by arrows. The logs of No. 001 to No. 004 are downlink data, and the logs of No. 005 to No. 008 are uplink data.

“Primitive” illustrates a setting instruction between respective layers.

“BTS” indicates a (pseudo) base station number that is a BTS number. The test device 50 has a function of a plurality of base stations for a test related to a handover.

“Channel” indicates which communication channel is used in a communication.

“Progress Time” is a timing that is generated in the timing generation unit 561 and is attached to a log.

The communication data information display area 25 includes “Message”. “Message” indicates a message name or a message type.

In the present embodiment, the message name or the message type is shown only in the logs of the top layers (in an example shown in FIG. 4, only logs of No. 001 and No. 008). However, the message name or the message type may be shown only in at least one of layers other than the top layers. In the example shown in FIG. 4, the message name is “RRC CONNECTION RECONFIGURATION”, and the response message from the communication terminal 10 (log of No. 008) is “RRC CONNECTION RECONFIGURATION COMPLETE.”

Further, the communication data information display area 25, as shown as rows 26 and 27 of two stages in the lower part of the first display screen 21, includes an area in which communication data of the log that is designated by an operation of an operator through the operation unit 43 is displayed. Among the rows 26 and 27 of two stages, an area in an upper stage displays a conversion of communication data (for example, displayed as “RLC: DL-DTCH-Message: message: C1 . . . ”), and an area in a lower stage displays HEX (for example, displayed as “0x 0A E2 FF 35 9B . . . ”). In the present embodiment, the communication data is displayed only in the logs of the top layers (in the example shown in FIG. 4, only in logs of No. 001 and No. 008). However, the communication data may be displayed in at least one among layers other than the top layers. In this example, as will be described later, the log data of No. 003 is designated by the operator, and for example, is highlight displayed. The highlight display is not essential.

Returning to the description of the operation, the operator confirms the log data by the first display screen 21. Then, it is assumed that any one of log data, here, log data in downlink of No. 003 is designated by the operator (step 105). Then, the display control unit 42 outputs the designated log data to the specific message processing unit 51 (step 106).

The specific message processing unit 51 outputs communication data related to the acquired log data to the layer processing unit 54. Here, the specific message processing unit 51 specifies the layer (35d) of the destination of the communication data (see FIG. 2) based on the log header information of the log data 30, and outputs the communication data to the specified layer (step 107). Since log data of No. 003 is designated in the example shown in FIG. 4, the destination layer of the communication data included in the log data is “MAC.” Therefore, the specific message processing unit 51 outputs the communication data to the MAC layer.

Here, in step 107, the operator can edit the communication data. For example, the communication data editing unit 511 edits the communication data, according to operation information that is input by an operator through an operation unit 43. For example, the communication data may be edited to intentionally cause an error in a communication, or may be edited to modify an error that a tester already recognized.

When the communication data is edited, the specific message processing unit 51 outputs the communication data after being edited to the layer processing unit 54. In this manner, the communication data is editable, and thus the tester can confirm a response of the communication terminal 10 in the communication data after being edited, in a second display screen 22 that will be described later.

The layer processing unit 54 performs a layer processing of downlink on the acquired communication data (step 108). Further, in this case, the log data generation unit 56 generates as log data, a log of communication data between layers at this time, similar to the steps of the original test, and the log data storage unit 57 stores the log.

The communication unit 55 transmits the communication data that is output from the layer processing unit 54 to the communication terminal 10 through the digital I/F unit 552 or the RF transceiver 551 (step 109). Then, the communication terminal 10 performs response processing on the communication data, and transmits a predetermined data to the test device 50. The communication unit 55 receives data in uplink that is transmitted from the communication terminal 10 through the digital I/F unit 552 or the RF transceiver 551 (step 110).

The layer processing unit 54 performs a layer processing of uplink of data that is received through the communication unit 55 (step 111). Further, in this case, the log data generation unit 56 generates as log data, a log of communication data between layers at this time, similar to the steps of the original test and the log data storage unit 57 stores the log.

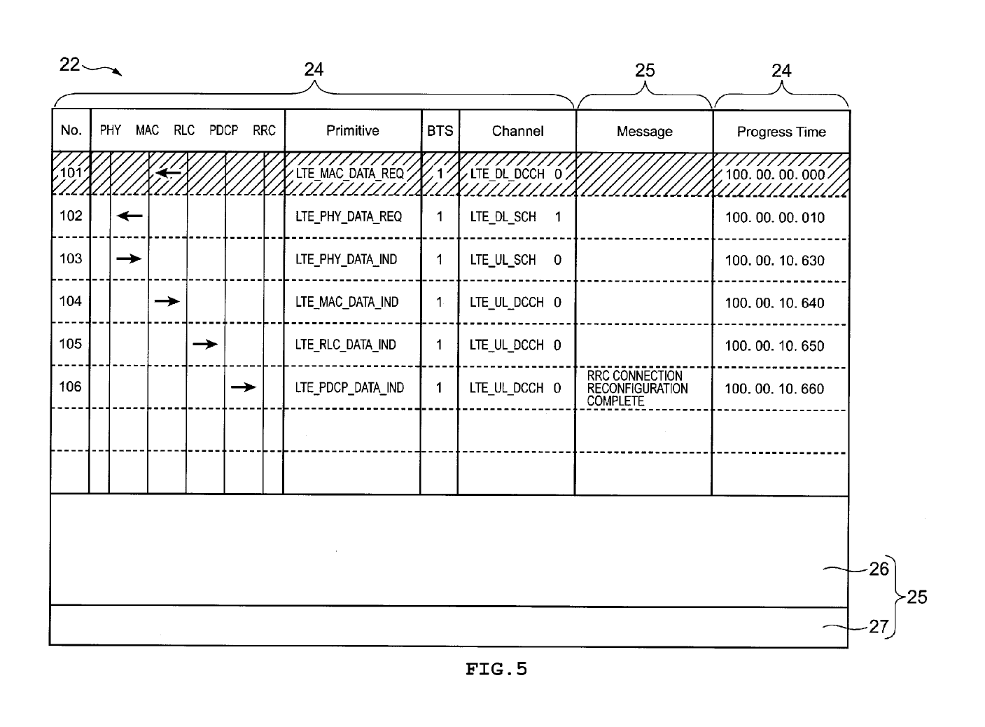

The display control unit 42 displays a second display screen 22 that displays log data in the reproduction test, that is, log data by the layer processing in steps 108 and 111 (step 112). FIG. 5 illustrates an example of the second display screen 22. The first display screen 21 and the second display screen 22 are displayed side-by-side, or alternatively displayed.

In the example of the second display screen 22, for example, log data of No. 101 starting from the processing of the MAC layer is highlight displayed. The highlight displayed log data corresponds to the log data that is designated by the operator. Here, the highlight display may not be necessary.

The tester confirms the result of the reproduction test by observing the log data displayed on the second display screen 22.

For example, as a case in which the test device 50 according to the present embodiment described above is used, a case may be considered in which some abnormality is confirmed in communication data transmitted from the communication terminal 10 in original test steps. In this case, in the first display screen 21, a message name of log data (No. 008) of a top level in uplink is not “˜COMPLETE”, but for example, is “NACK”, “˜REJECT”, or “˜FAILURE.” However, without being limited to the case in which the abnormality has occurred, the test device 50 can designate any log data to an operator, and transmit communication data of the designated log data.

As described above, in the present embodiment, the specific message processing unit 51 re-transmits communication data related to any log data designated by the operator, among log data for each layer that is processed by the layer processing unit 54. In other words, the test device 50 can reproduce an operation of a scenario of a place that is designated by the operator, that is, a portion of the test scenario among data of the test scenario. Accordingly, for example, compared to a case in which an entire test scenario is executed from the beginning, it is possible to shorten the time for a reproduction test. Further, in order to perform a portion of the test scenario, it is not necessary for the tester to modify the test scenario, and thereby reducing an effort of a tester required for a test.

Further, according to the present embodiment, it is not necessary to modify the test scenario as described above, and thereby achieving effects described as follows: In other words, even in a case where the tester was not an author of a test scenario or could not write a test scenario, when the tester is able to understand at least a portion of content of the scenario, the tester can perform a reproduction test only by designating log data.

Here, even if the test scenario is re-executed from the beginning, all conditions of the reproduction test may not be coincident with the original test condition. For example, in a test of measuring an error rate, in a case of using random data of a PN code as pseudo data of user data to be transmitted to the communication terminal 10 (for example, content data of a mail, moving image data, and the like), whenever the test scenario is executed, the communication data 36 changes. Contrary to this, in the present embodiment, communication data of the original test is used, and thus it is possible to make the communication data 36 in the original test be equal to the communication data 36 in the reproduction test. In other words, identity of the test conditions are enhanced, so reproducibility can be improved.

Since the present embodiment is configured such that the operator can designate any log data, it is possible to perform a reproduction test from a destination layer of the designated log data when log data between middle layers other than the top layers is designated, without being limited to log data of the top layers. Accordingly, it is possible to enhance a processing efficiency by the layer processing unit 54 (processing numbers are reduced), and to shorten a processing time.

Further, since the present embodiment is configured such that the operator can edit communication data of any layer to transmit the edited communication data, the cause of abnormality due to a processing of each layer is easily specified.

The test device 50 according to the present embodiment can transceive data in the digital I/F unit 552, and thereby performing a communication test, even if the RF transceiver 13 of the communication terminal 10 is not normal. Alternatively, it is possible to perform a communication test by removing the cause of an abnormality in a RF signal processing.

### Second Embodiment

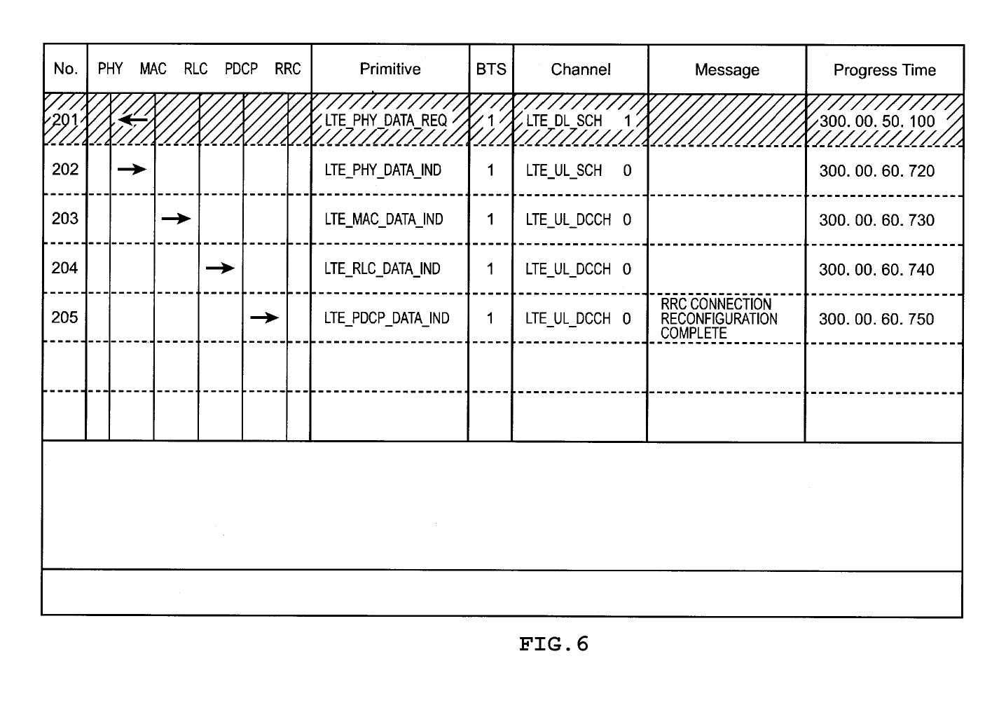

An operation of a test device according to a second embodiment of the present invention will be described. FIG. 6 illustrates a display screen (second display screen) of log data of a reproduction test result by the operation. In the second embodiment, the description of the same functions and operations as those of the test device 50 shown in the first embodiment will be simplified or omitted, and the description will be focused on the different parts.

In the test according to the present embodiment, steps 101 to 106 shown in FIG. 3 are performed first. The specific message processing unit 51 selects any one piece of communication data among each communication data between layers including information related to a message included in the log data 30 designated in step 106 and outputs the selected communication data to the corresponding layer. That is, the information related to the message includes a message name, message content, and the like. In the present operation, among communication data (between respective layers) having the same message content as the message within the designated log data, any one piece of communication data is selected and output.

For example, if the operator designates log data of No. 003 (otherwise, No. 001 is possible) as illustrated in FIG. 4, the specific message processing unit 51 outputs the communication data of any one log data among log data of No. 001 to 004 to the layer processing unit 54.

The example of the second display screen 22 shown in FIG. 6 displays a result in which communication data to be output to the bottom layer “PHY” is selected. In this manner, when any one is selected among log data of communication data between four downlink layers by the operator, communication data to be output to the bottom layer among communication data between four layers is automatically selected. Accordingly, a processing efficiency by the layer processing unit 54 is enhanced and a processing time can be shortened.

### Other Embodiment

The present invention is not limited to the aforementioned embodiment, but can be realized by other various embodiments.

The system including the test device according to each embodiment uses a LTE scheme as a communication scheme, but other communication schemes may be used without being limited thereto.

The communication unit 55 of the test device 50 according to the embodiments includes both the RF transceiver 551 and the digital I/F unit 552, but may include any one of them.

The communication data editing unit 511 according to the embodiments edits the specified communication data based on the operation information that is input by the operator. However, the communication data editing unit 511 may edit the specified communication data according to a predetermined algorithm, without depending on operation information of an operator.

It is possible to combine at least two characteristics out of the characteristics of each of the embodiments that are described above.

### DESCRIPTION OF REFERENCE NUMERALS AND SIGNS

10 . . . a mobile communication terminal

11 . . . processing unit

12 . . . layer processing unit

30 . . . log data

35 . . . log header

36 . . . communication data

50 . . . test device

51 . . . specific message processing unit

52 . . . scenario processing unit

53 . . . message processing unit

54 . . . layer processing unit

55 . . . communication unit

56 . . . log data generation unit

57 . . . log data storage unit

511 . . . communication data editing unit

551 . . . RF transceiver

552 . . . digital I/F unit

1. A test device for a mobile communication terminal, comprising:
a message processing unit capable of generating a message to be transmitted to the mobile communication terminal that is a test subject, according to a test scenario describing content and sequence of transmitting and receiving the message based on a predetermined communication protocol;
a layer processing unit that is configured of a plurality of layers based on the communication protocol and processes data of the generated message for each layer;
a communication unit capable of transmitting data of the message processed by the layer processing unit to the mobile communication terminal;
a log data generation unit that generates as log data, logs of communication data between layers in the layer processing unit;
a display unit that displays the logs based on the log data;
an operation unit that designates any log from the logs displayed on the display unit; and
a specific message processing unit that specifies log data in downlink related to the designated log and outputs communication data included in the specified log data as specific communication data to the layer processing unit,
wherein the test device outputs the specific communication data from the communication unit to the mobile communication terminal through the layer processing unit.

2. The test device for a mobile communication terminal according to claim 1,
wherein the specific message processing unit specifies a layer of a destination of the specific communication data based on log header information included in the designated log data, and outputs the specific communication data to the specified layer.

3. The test device for a mobile communication terminal according to claim 1,
wherein the specific message processing unit includes a communication data editing unit that edits the specific communication data related to the designated log data, and when the specific communication data is edited, outputs the edited specific communication data.

4. The test device for a mobile communication terminal according to claim 1,
wherein the communication unit includes a digital interface that transmits a baseband signal of data of the message processed by the layer processing unit.

5. The test device for a mobile communication terminal according to claim 1,
wherein the specific message processing unit selects and outputs as the specific communication data, any one piece of communication data among communication data between layers including information related to a message included in the designated log data.

6. The test device for a mobile communication terminal according to claim 5,
wherein the specific message processing unit selects as the specific communication data, communication data to be output to a bottom layer among the communication data between layers.

7. A test method for a mobile communication terminal comprising:
a message generation step that generates a message to be transmitted to the mobile communication terminal that is a test subject, according to a test scenario describing content and sequence of transmitting and receiving the message based on a predetermined communication protocol;
a layer processing step that processes data of the generated message for each layer, in a plurality of layers based on the communication protocol;
a communication step that transmits data of the message that is processed in the layer processing step to the mobile communication terminal;
a log data generation step that generates as log data, logs of communication data between layers in the layer processing step;
a log display step that displays the logs based on the log data;
a log designation step that designates any log from the displayed logs;
a specific communication data output step that specifies log data in downlink related to the designated log and outputs communication data included in the specified log data as specific communication data;
a second layer processing step that processes the specific communication data in the layer; and
a second communication step that transmits the specific communication data processed in the second layer processing step to the mobile communication terminal.

8. The test method for a mobile communication terminal according to claim 7,
wherein the specific message processing step specifies a layer of a destination of the specific communication data based on log header information included in the designated log data, and outputs the specific communication data to the specified layer.

9. The test method for a mobile communication terminal according to claim 7, further comprising:
a communication data editing step that edits the specific communication data related to the designated log data,
wherein when the specific communication data is edited, the specific message processing step outputs the edited specific communication data.

10. The test method for a mobile communication terminal according to claim 7,
wherein the communication step and the second communication step transmit as a digital baseband signal, data of the message processed in the layer processing step or the specific communication data processed in the second layer processing step to the mobile communication terminal.

11. The test method for a mobile communication terminal according to claim 7,
wherein the specific message processing step selects and outputs as the specific communication data, any one piece of communication data among communication data between layers including information related to a message included in the designated log data.

12. The test method for a mobile communication terminal according to claim 11,
wherein the specific message processing step selects as the specific communication data, communication data to be output to a bottom layer among the communication data between layers.
